(19) United States
(12) Patent Application Publication
(10) Pub. No.: US 2004/0255727 A1
(43) Pub. Date: Dec. 23, 2004

(54) Tub drain wrench

(76) Inventor: James A. Kovach, Parma, OH (US)

Correspondence Address: WATTS, HOFFMANN, FISHER & HEINKE CO., L.P.A., 1100 Superior Ave., Ste. 1750, Cleveland, OH, 44114, US

(21) Appl. No.: 10/602,406

(22) Filed: Jun. 23, 2003

(51) Int. Cl. B25B 13/56

(52) U.S. Cl. 81/176.15

(57) ABSTRACT

A drain spud wrench having a wrench body, a first end portion and a second end portion. The first end portion extends from the wrench body in alignment with a longitudinal axis of the wrench body. The first end portion includes structure that is configured to engage a drain spud. The second end portion extends from the wrench body in a direction opposite from the first end portion. The second end portion defines a polygonal recess configured to accept a standard socket drive. In one embodiment, the polygonal recess is sized and shaped to accept toilet seat nuts.

### FIELD OF THE INVENTION

The present invention relates to plumbing tools and more particularly to a wrench for installing and removing of tub or sink drain spuds or fittings.

### BACKGROUND OF THE INVENTION

In the plumbing art, a “spud” is a fitting that channels waste liquid from a tub or a sink to a drain pipe while providing a seal between the tub or sink and the drain pipe. The typical spud is a cylindrical sleeve-like member having a flared upper end that is engaged around the tub or sink drain opening and an externally threaded body that projects through the drain opening to a lower end that is threaded into the drain pipe. A nut on the spud body clamps the flared end in place about the drain opening. The flared spud end and the nut engage respective seal rings that extend about the drain opening so that the spud sealingly engages the tub or sink. The lower spud end is provided with a strainer. Most often the strainer is formed by four equiangularly spaced spokes that project from the smooth cylindrical inner spud wall toward the longitudinal axis of the spud to provide a generally cruciform strainer. It is often difficult to install or remove a spud from a sink or tub, since the typical spuds do not include structure that is easily engaged by conventional tools.

FIG. 1 illustrates a prior art spud wrench. One such spud wrench is disclosed by U.S. Pat. No. 4,237,754 (the '754 patent) to Battrick. The '754 patent discloses a universal spud wrench that comprises a tubular shaft units separate spud at each shaft end. The spud removal structures are sized to engage differently sized spuds. A rod placed through a hole drilled transversely through the shaft facilitates turning the spud wrench.

### SUMMARY OF THE INVENTION

According to the invention, a spud wrench is provided that includes a wrench body and first and second end portions. The first end portion extends from the wrench body in alignment with a longitudinal axis of the wrench body. The first end portion includes structure configured to engage a spud. The second end portion extends from the wrench body in a direction opposite from the first end portion. The second end portion defines a polygonal recess centered on the longitudinal axis that is configured to accept a standard socket drive.

In one embodiment, the second end portion also includes structure configured to engage a spud. In this embodiment, the first and second end portions are configured and sized to engage respective drain spuds having different inner diameters.

In an illustrated embodiment of the invention, the first end portion may also include a polygonal recess for accepting a standard socket drive. In this embodiment, a socket drive may be inserted into either the first end portion or the second end portion to drive the spud wrench. In one embodiment, one or both of the polygonal recesses are sized and shaped to accept a toilet seat nut. For example, the polygonal recesses may have a ½ inch long square cross-section that accepts a ½ inch square toilet seat nut. The recesses in the first and/or second end portion may be stepped to provide axially spaced polygonal cross section receptacles shaped for receiving alternative socket drives. The additional polygonal receptacles allow more than one standard socket size to be inserted into the end portion of the wrench. For example, one or both of the end portions may include recesses that are sized to accept a standard square ½ inch drive, and/or a standard square ⅜ inch drive.

In one embodiment, an end portion that engages a drain spud includes spaced projections. The spaced projections define first and second generally orthogonal channels that accept a cruciform shaped portion of the drain spud.

In one embodiment, the spud wrench is used along with a standard socket driver and socket drive extension. In this embodiment, the socket drive extension is inserted into one tub drain wrench end. The socket drive extension is connected to the socket driver. The socket drive is rotated to remove the drain spud. For example, the socket drive may be a standard ratchet handle that is rotated to drive the drain wrench to remove the drain spud.

Additional features and advantages will become apparent from the following description of an illustrated embodiment made with reference to the accompanying drawings which form part of the specification.

### BRIEF DESCRIPTION OF THE DRAWINGS.

FIG. 1 is a perspective view that illustrates a prior art spud;

FIG. 2 is an elevational view, partially in section, of a drain wrench of the present invention positioned in a tub above a drain;

FIG. 3 is a view of the drain wrench taken along the plane indicated by line 3-3 of FIG. 2;

FIG. 4 is a perspective view that illustrates the drain wrench of the present invention positioned above a spud;

FIG. 5 is a perspective view that illustrates use of the drain wrench of the present invention with a socket drive to remove a spud; and,

FIG. 6 is a partial sectional view that illustrates the drain wrench of the present invention used to remove a toilet seat nut.

### DETAILED DESCRIPTION

The present invention concerns a spud wrench 10. The spud wrench includes a wrench body 12, and first and second end portions 14, 16 that extend from the wrench body 12. The first end portion 14 is in alignment with a longitudinal axis A of the wrench body 12. The first end portion 14 includes structure 18 configured to engage a drain spud 20. The second end portion 16 extends from the wrench body 12 in a direction opposite from the first end portion. The second end portion 16 defines a polygonal recess 22 that is configured to accept a standard socket drive 24.

The first end portion 14 is configured to engage a drain spud 20 having a relatively smaller size. In the illustrated embodiment, the second end portion 16 includes structure 26 configured to engage a drain spud having a relatively larger size. The illustrated first end portion includes a second polygonal recess 28 for accepting a standard socket drive.

### Wrench Body

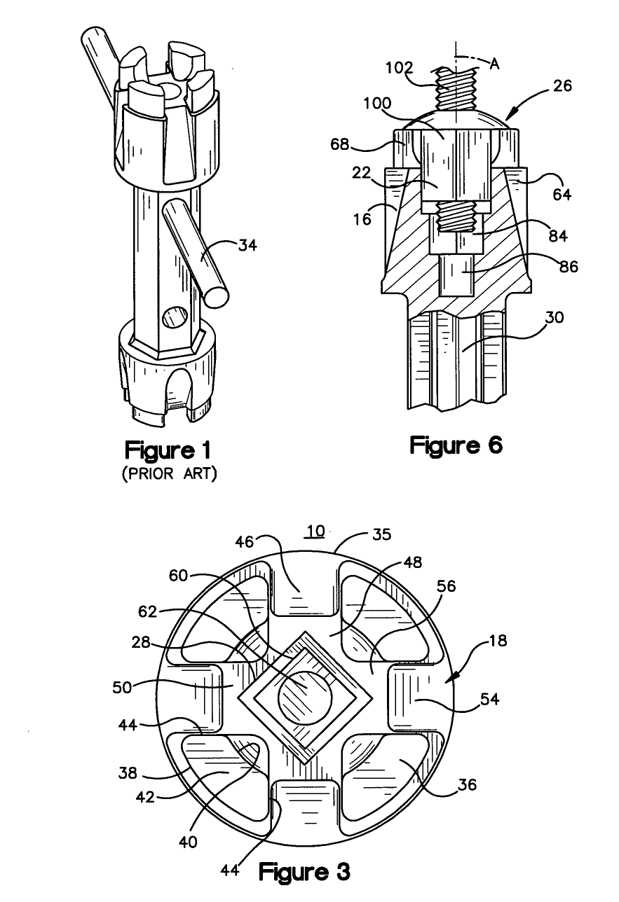

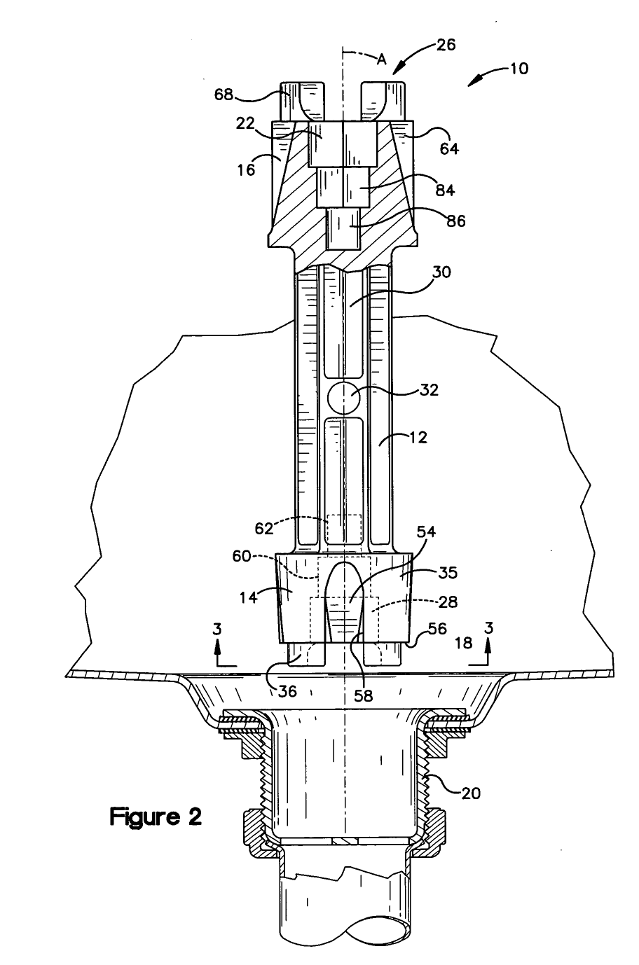

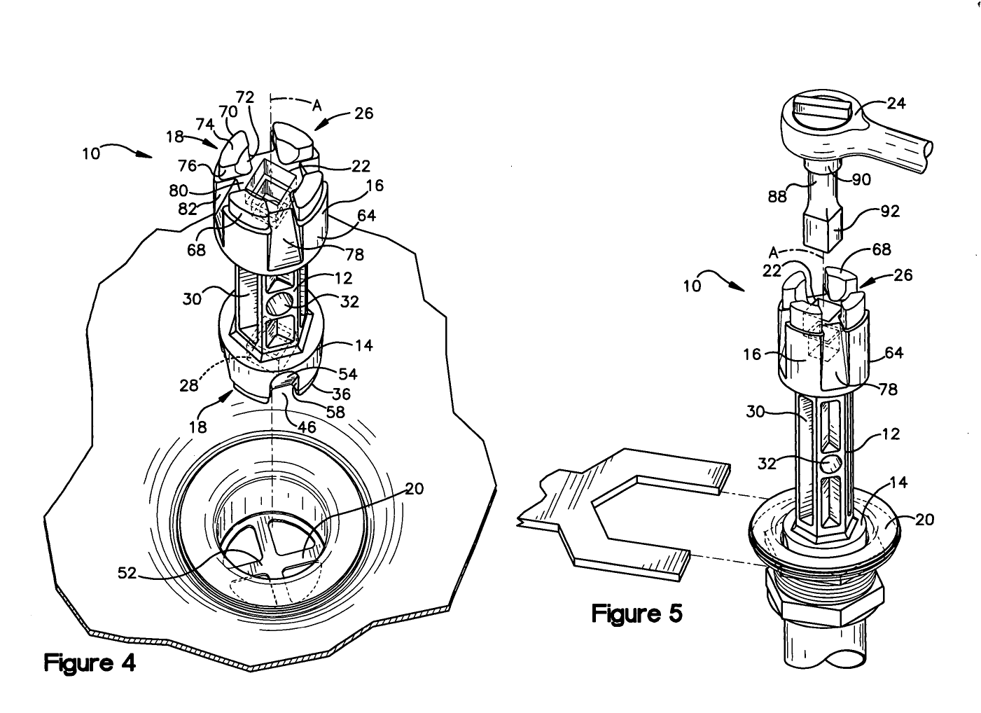

Referring to FIGS. 2 and 4, the illustrated wrench body 12 is an elongated shaft. The illustrated wrench body is generally polygonal, allowing it to be engaged by a wrench or other suitable tool. In the exemplary embodiment, the wrench body 12 includes recesses 30 that reduce the amount of material needed to construct the wrench body. The illustrated wrench body includes a bore 32 that is generally orthogonal to the axis A of the wrench body. The bore 32 is sized to accept a shaft 34 (see Prior Art FIG. 1) that can be used to turn the drain wrench. The wrench body 12 extends between the first end portion 14 and the second end portion 16.

### First End Portion

The first end portion 14 includes a generally circular extension 35 and the spud engaging structure 18. The illustrated spud engaging structure 18 includes four equally spaced projections 36 that extend from the generally circular extension 35. The projections 36 are bound by concentric surfaces 38, 40, end surface 42, and radial surfaces 44. The radial surfaces 44 define gaps 46 between the extensions 36. The gaps 46 are symmetric about the axis A, defining first and second generally orthogonal channels 48, 50. The orthogonal channels accept a cross-shaped portion 52 of a drain spud 20.

In the illustrated embodiment, four slots 54 are included in the generally circular extension 35. The four slots 54 are aligned with the four gaps between the projections 36. The slots extend from face surface 56 along the length of the generally circular extension 35, and are sloped radially outward from the axis A of the tool of the wrench body. The surface defined by the slots 54 on the outside of the extension 35 may be utilized to install and/or removal of larger spuds by inserting the drain wrench into the spud, and engaging the spud with radial surfaces 58 defined by the slots 54.

In the illustrated embodiment, the polygonal recess 28 extends axially inward from the face surface 56 of the first end portion 14 forming a receptacle. The polygonal recess 28 extends axially into the extension 35 and/or the wrench body 12. This receptacle is configured to accept a standard socket drive 24. This allows the drain wrench to be easily turned using a standard socket driver. In the illustrated embodiment, the polygonal recess is a square recess. The square recess accepts a standard generally square socket drive. For example, the recess 28 may accept a square ⅜″, or ½″ standard socket drive. In an alternate embodiment, the recess could be formed to accept a driver having an other polygonal shape. For example, the recess could be shaped to accept a hex drive, a star-shaped drive, a torqx drive or any other suitable drive in an alternate embodiment.

Referring to FIG. 2, the illustrated polygonal recess 28 is stepped, forming a second polygonal receptacle 60 that extends axially inward from the first receptacle formed by the polygonal recess 28. The second polygonal receptacle 60 extends axially further into the extension 35 and/or the wrench body 12. The second polygonal receptacle is configured to accept a standard socket drive. In the illustrated embodiment, the second polygonal receptacle 60 is a square recess that extends axially inward from the polygonal recess 28. The second polygonal receptacle accepts a standard smaller generally square socket drive. For example, the recess 28 may accept a square ½″ socket drive while the second polygonal receptacle 60 accepts a ⅜″ drive. It should be readily apparent that the second polygonal recess need not be the same shape as the first polygonal recesses.

In one embodiment, the recess 28 includes two steps, forming a circular receptacle 62 that is axially inward of the second polygonal receptacle 60.

### Second End Portion

The illustrated second end portion 16 is larger than the first end portion. The larger size of the second end portion allows it to remove larger spuds 20. The second end portion 16 includes a generally circular extension 64 and spud engaging structure 26. The generally circular extension 64 has a diameter that is larger than the diameter of the generally circular extension 35. The illustrated spud engaging structure 26 includes four equally spaced projections 68 that extend from the generally circular extension 64. The projections 68 are bound by concentric surfaces 70, 72, end surface 74, and radial surfaces 76. The projections 68 are similar to the projections 36, but are larger. In the illustrated embodiment, the concentric surfaces 70, 72 have larger diameters than the concentric surfaces 38, 40 respectively and the length of the projections 68 is greater than the length of the projections 36.

In the illustrated embodiment, four slots 78 are included in the generally circular extension 64. The four slots 78 are aligned with the gaps between the projections 36. The slots extend from face surface 80 along the length of the generally circular extension 64, and are sloped radially outward from the axis A. The surface defined by the slots 78 may be utilized to install and/or removal spuds by inserting the drain wrench into the spud, and engaging the spud with radial surfaces 82 defined by the slots 54.

In the exemplary embodiment, the polygonal recess 22 extends axially inward from the face surface 80. In the illustrated embodiment, the polygonal recess 22 in the second end portion is substantially the same as the polygonal recess 28 in the first end portion and is therefore not described in detail. In the illustrated embodiment, the illustrated polygonal recess 22 is stepped, forming a second polygonal receptacle 84 that extends axially inward from the first receptacle defined by the polygonal recess. The illustrated second polygonal receptacle 84 in the second end portion 16 is substantially identical to the second polygonal receptacle 60 in the first end portion 14 and is therefore not described in detail. In one embodiment, the polygonal recess 22 includes two steps forming a circular receptacle that is axially inward of the second polygonal receptacle. The two end portions 14, 16 can be used to install or remove many different types of drain spuds.

### Use with a Socket Drive

Referring to FIG. 5, the drain wrench 10 can be assembled to a socket drive 24 and a socket drive extension 88. A first end 90 of the extension 88 is removably connected to the socket drive 24. A second end 92 of the extension extends into one of the polygonal recesses of the drain wrench 10. In the illustrated embodiment, the drain wrench is coupled to a tub drain spud 20 by engaging a cross-shaped portion 96 of the drain spud with the transverse channels of one of the end portions. In the illustrated embodiment, one of the face surfaces 56, 80 abut the drain spud 20. The socket drive 20 is rotated to thereby rotate the drain wrench 10 to remove the spud 20.

### Use to Remove Toilet Seat Nuts

FIG. 6 illustrates one embodiment where the wrench 10 is used to remove a toilet seat nut 100. In this embodiment, the recesses 22, 28 are sized and shaped to engage a toilet seat nut. In the illustrated embodiment, the recesses 22, 28 are ½″ square recesses that engage a ½″ square toilet seat nut. To remove or tighten a toilet seat nut 100, one of the recesses 22, 28 are placed over the toilet seat nut 100. The wrench 10 is rotated to rotate the nut 100 with respect to the toilet seat screw 102 to loosen or tighten the connection.

While the invention has been illustrated and described in considerable detail the invention is not to be considered limited to the precise constructions disclosed. Various adaptations, modifications and uses of the invention may occur to those skilled in the art to which the invention relates. The intention is to cover hereby all such adaptations, modifications and uses that fall within the spirit or scope of the appended claims.

We claim:

1. A drain spud wrench, comprising:
a) a wrench body having a longitudinal axis;
b) a first end portion extending from said wrench body in alignment with said longitudinal axis comprising structure configured to engage a drain spud; and
c) a second end portion extending from said wrench body in a direction opposite from said first end portion, said second end portion defining a polygonal recess configured to accept a standard socket drive.

2. The drain spud wrench of claim 1 wherein said first end portion is configured to engage a drain spud having a first size and said second end portion is configured to engage a drain spud having a second size.

3. The drain spud wrench of claim 1 wherein said first end portion includes a second polygonal recess for accepting a standard socket drive.

4. The drain spud wrench of claim 1 wherein said second end portion further defines a second polygonal recess that is axially aligned with the first recess and axially spaced from the first recess.

5. The drain spud wrench of claim 1 wherein said recess is square and sized to accept a standard ½″ socket drive.

6. The drain spud wrench of claim 1 wherein said recess is square and sized to accept a standard ⅜″ socket drive.

7. The drain spud wrench of claim 1 wherein the polygonal recess is configured to accept a toilet seat nut.

8. The drain spud wrench of claim 4 wherein said second polygonal recess is square and sized to accept a ⅜″ socket drive.

9. The drain spud wrench of claim 1 wherein said first end portion includes spaced projections that define first and second generally orthogonal channels that accept a cross-shaped portion of said drain spud.

10. A drain spud wrench, comprising:
a) a wrench body having a longitudinal axis;
b) a first end portion extending from said wrench body having a first plurality of projections that define first and second transverse channels for receiving a cross-shaped portion of a drain spud;
c) a first polygonal recess sized to accept a standard sized socket drive defined radially inward and axially spaced from said first and second transverse channels;
d) a second polygonal recess that is smaller than said first polygonal recess defined axially inward of said first polygonal recess, said second recess being sized to accept a standard sized socket drive;
e) a second end portion extending from said wrench body in a direction opposite from said first end portion, said second end portion includes a second plurality of projections that define third and fourth transverse channels for receiving a cross-shaped portion of a drain spud of second size;
f) a third polygonal recess sized to accept a standard sized socket drive defined axially inward of said third and fourth generally transverse channels; and
g) a fourth polygonal recess that is smaller than said third polygonal recess defined axially inward of said third polygonal recess, said fourth recess being sized to accept a standard sized socket drive.

11. A drain spud wrench assembly comprising:
a) a socket driver;
b) a socket drive extension removably connected to said socket driver;
c) a drain wrench including a wrench body having a longitudinal axis, a first end portion extending from said wrench body in alignment with said longitudinal axis comprising structure configured to engage a drain spud, and a second end portion extending from said wrench body in a direction opposite from said first end portion, said second end portion defining a polygonal recess configured to accept a standard socket drive.

12. The drain spud wrench assembly of claim 11 wherein said first end portion is configured to engage a drain spud having a first size and said second end portion is configured to engage a drain spud having a second size.

13. The drain spud wrench assembly of claim 11 wherein said first end portion includes a second polygonal recess sized to accept a standard sized socket drive.

14. The drain spud wrench assembly of claim 11 wherein said first recess is a square recess and said second end portion further defines a second smaller square recess that is axially aligned with said first recess and is axially spaced from said first recess, said socket drive extension is coupled in said first recess or said second recess.

15. The drain spud wrench assembly of claim 11 wherein said structure configured to engage a drain spud comprises spaced projections that define first and second transverse channels that accept a cross-shaped portion of said drain spud.

16. A drain spud wrench assembly comprising:
a) a socket driver;
b) a socket drive extension removably connected to said socket driver;
c) a drain wrench coupled to said extension including:
i) a wrench body having a longitudinal axis;
ii) a first end portion extending from said wrench body having a first plurality of projections that define first and second transverse channels for receiving a cross-shaped portion of a tub drain spud;
iii) a first polygonal recess sized to accept a standard sized socket drive defined radially inward and axially spaced from said first and second transverse channels;
iv) a second polygonal recess that is smaller than said first polygonal recess defined axially inward of said first polygonal recess, said second recess being sized to accept a standard sized socket drive;
v) a second end portion extending from said wrench body in a direction opposite from said first end portion, said second end portion includes a second plurality of projections that define third and fourth transverse channels for receiving a cross-shaped portion of a tub drain spud of second size;
vi) a third polygonal recess sized to accept a standard sized socket drive defined axially inward of said third and fourth generally transverse channels; and
vii) a fourth polygonal recess that is smaller than said third polygonal recess defined axially inward of said third polygonal recess, said fourth recess being sized to accept a standard sized socket drive.

17. A method of removing a drain spud from a tub or basin, comprising:
a) inserting a socket drive into a first end portion of a drain wrench;
b) engaging a drain spud with a second end portion extending in a direction opposite from said first end portion; and
c) rotating said socket drive to remove said drain spud.

18. A method of removing a drain spud from a tub or basin, comprising:
a) coupling a socket drive to a drain wrench that includes:
i) a first end portion that defines first and second transverse channels that accept a cross-shaped portion of a drain spud having a first size;
ii) a first polygonal recess sized to accept a standard sized socket drive defined axially inward of said first and second transverse channels;
iii) a second polygonal square recess that is smaller than said first polygonal recess in alignment with said first polygonal recess and axially spaced from said first polygonal recess, said second recess being sized to accept a standard sized socket drive;
iv) a second end portion that defines third and fourth transverse channels that accept a cross-shaped portion of a drain spud having a second size;
v) a third polygonal recess sized to accept a standard sized socket drive defined axially inward of said third and fourth transverse channels; and
vi) a fourth polygonal square recess that is smaller than said third polygonal recess in alignment with said third polygonal recess and axially spaced from said third polygonal recess, said fourth recess being sized to accept a standard sized socket drive;
b) coupling said drain wrench and to said tub drain spud by engaging a cross-shaped portion of said drain spud with said transverse channels of one of said first end portion and said second end portion; and
c) rotating said socket drive to remove said drain spud.
